(19) United States
(12) Patent Application Publication
(10) Pub. No.: US 2023/0305491 A1
(43) Pub. Date: Sep. 28, 2023

(54) CONTROL DEVICE FOR A TIMEPIECE

(71) Applicant: BULGARI HORLOGERIE SA, Neuchâtel (CH)

(72) Inventors: Jean-Nicolas Rochat, Les Charbonnières (CH); Julien Behra, Les Rousses (FR)

(73) Assignee: BULGARI HORLOGERIE SA, Neuchâtel (CH)

(21) Appl. No.: 18/158,432

(22) Filed: Jan. 23, 2023

(30) Foreign Application Priority Data
Jan. 24, 2022 (CH) 000067/2022

(51) Int. Cl. G04B 3/04; G04B 13/02; G04B 27/00

(52) U.S. Cl. CPC G04B 3/041; G04B 13/027; G04B 27/001

(57) ABSTRACT

A control device (1) for a timepiece
(200) includes: an input (2), intended to be rotated by action of a user in a first direction or in a second
direction, a first unidirectional connector (3), intended to mechanically connect the input (2) to a first mechanism (5) providing a first timepiece function,
and a second unidirectional connector (4), intended to mechanically connect the input (2) to a second mechanism (6) providing a second timepiece
function, the first unidirectional connector (3) arranged and/or configured to drive the first mechanism (5) exclusively when the input is manoeuvred in the first
direction, the second unidirectional connector (4) arranged and/or configured to drive the second mechanism (6) exclusively when the input is manoeuvred in the second direction, the first unidirectional connector (3) having first toothings (321, 331) which interact irreversibly and/or the second unidirectional connector (4) having second toothings (421, 431) which interact irreversibly.

### RELATED APPLICATION

This application claims priority of Swiss patent application No. CH000067/2022 filed Jan. 24, 2022, the content of which is hereby incorporated by reference herein in its entirety.

### TECHNICAL FIELD OF THE INVENTION

The invention relates to a control device for a timepiece. The invention also relates to a timepiece movement comprising such a control device. The invention lastly relates to a timepiece comprising such a control device or such a timepiece movement.

### BACKGROUND ART

Timepieces are equipped with a control device that serves to actuate a mechanism of the timepiece, such as a mechanism for rewinding a barrel or a mechanism for adjusting the time or adjusting another timepiece function, like a calendar indication or lunar phase. The control device conventionally comprises a crown that is connected to a rod and manipulable by a user. Various axial positions of the rod-crown assembly make it possible to define selections of various timepiece functions and the rotation of the crown in each of these positions makes it possible to act on the timepiece functions. For example:
a rotation of the crown when it is in a first axial position makes it possible to rewind the barrel,
a rotation of the crown when it is in a second axial position makes it possible to correct an indication of the date, and
a rotation of the crown when it is in a third axial position makes it possible to correct an indication of the time or to set the time.

In certain timepiece configurations, the solution such as that mentioned above cannot be implemented, or in that case it is not desirable to implement the solution mentioned above.

### SUMMARY OF THE INVENTION

The aim of the invention is to provide a control device which remedies the above drawbacks and improves the control devices known from the prior art. In particular, the invention proposes a control device which is compact, simple and easy to use.

According to the invention, the control device is defined by point 1 below.

1. Control device for a timepiece, comprising:
an input, which is intended to be rotated by the action of a user in a first direction or in a second direction,
a first unidirectional connector, which is intended to mechanically connect the input to a first mechanism providing a first timepiece function, and
a second unidirectional connector, which is intended to mechanically connect the input to a second mechanism providing a second timepiece function,
   the first unidirectional connector being arranged and/or configured to drive the first mechanism exclusively when the input is manoeuvred in the first direction,
   the second unidirectional connector being arranged and/or configured to drive the second mechanism exclusively when the input is manoeuvred in the second direction,
   the first unidirectional connector comprising first toothings which interact irreversibly and/or the second unidirectional connector comprising second toothings which interact irreversibly.

Embodiments of the control device are defined by points 2 to 9 below.

2. Control device according to point 1, wherein the first unidirectional connector comprises:
a first planetary wheel carrier,
a first planetary wheel pivoted on the first planetary wheel carrier, and
a first sun gear meshing with the first planetary wheel,
the first toothings meshing irreversibly at the interface of the first planetary wheel and the first sun gear.

3. Control device according to either of the preceding points, wherein the first planetary wheel carrier makes up the input or is secured to the input and the first sun gear is intended to be secured to the first mechanism, or wherein the first planetary wheel carrier is intended to be secured to the first mechanism and the first sun gear makes up the input or is secured to the input.

4. Control device according to one of points 1 to 3, wherein the second unidirectional connector comprises:
a second planetary wheel carrier,
a second planetary wheel pivoted on the second planetary wheel carrier, and
a second sun gear meshing with the second planetary wheel,
the second toothings meshing irreversibly at the interface of the second planetary wheel and the second sun gear.

5. Control device according to one of the preceding points, wherein the second planetary wheel carrier makes up the input or is secured to the input and the second sun gear is intended to be secured to the second mechanism, or wherein the second planetary wheel carrier is intended to be secured to the second mechanism and the second sun gear makes up the input or is secured to the input.

6. Control device according to one of the preceding points, wherein the first toothings are Breguet toothings and/or the second toothings are Breguet toothings.

7. Control device according to one of points 1 to 6, wherein the first unidirectional connector is centred on a first axis and wherein the second unidirectional connector is centred on a second axis, the first and second axes being parallel and distinct.

8. Control device according to one of points 1 to 6, wherein the first unidirectional connector is centred on a first axis and wherein the second unidirectional connector is centred on a second axis, the first and second axes being one and a same.

9. Control device according to one of the preceding points and according to points 2, 4 and 8, wherein the first and second planetary wheel carriers form one and the same piece or are a monobloc assembly, or wherein the first and second sun gears form one and the same piece or are a monobloc assembly.

According to the invention, a timepiece movement is defined by point 10 below.

10. Timepiece movement comprising a control device according to one of points 1 to 9.

According to the invention, a timepiece is defined by point 11 below.

11. Timepiece, notably wristwatch, comprising:
a control device according to one of points 1 to 9, and/or
a timepiece movement according to the preceding point.

### BRIEF DESCRIPTION OF THE DRAWINGS

The subjects, features and advantages of the present invention are described in detail in the following nonlimiting description of one particular embodiment given with reference to the appended figure.

FIG. 1 is a schematic view of one embodiment of a timepiece according to the invention, in which circular local sections are shown to visualize the planetary wheels and the teeth of sun gears meshing with these planetary wheels.

### DETAILED DESCRIPTION OF PARTICULAR EMBODIMENTS

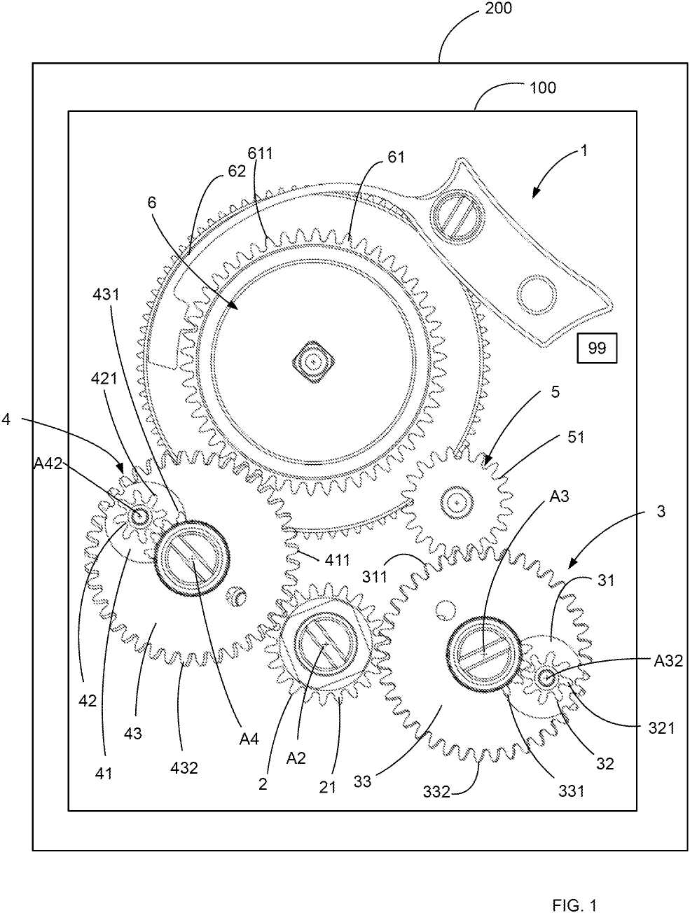

One embodiment of a timepiece 200 is described below in detail with reference to FIG. 1. The timepiece 200 is for example a watch, in particular a wristwatch. The timepiece 200 comprises a timepiece movement 100 intended to be mounted in a timepiece casing or case in order to protect it from the external environment. The timepiece movement 100 may be a mechanical movement, notably an automatic movement, or a hybrid movement.

The movement comprises:
a first mechanism 5 providing a first timepiece function,
a second mechanism 6 providing a second timepiece function, and
a control device 1 enabling a user to act on the first mechanism 5 and to act on the second mechanism 6.

This action is advantageously performed by the user via a crown or a knurling-roller or a key mechanically connected to the control device, in particular connected to an input 2 of the control device.

In the embodiment shown, the first mechanism 5 is a time-setting mechanism. This first mechanism comprises, for example, a drivetrain, notably a train of gearwheels for modifying the display of the time. This first mechanism comprises, for example, a minutes geartrain and/or a wheel 5 of a minutes disc.

In the embodiment shown, the second mechanism 6 is a rewinding mechanism. This first mechanism thus comprises a barrel 6 and, possibly, a drivetrain, notably a train of gearwheels for acting on the barrel 6, notably on a ratchet 61 of the barrel. The mechanism 6 may comprise a pawl 62 preventing the ratchet 61 from turning in the anticlockwise direction.

In alternative embodiments, the first mechanism 5 could provide another function, notably:
another correction function, such as a function for correcting a calendar indication (day, date, month, year, etc.) or a function for correcting another indication (for example lunar phase), or
a function for rewinding another barrel, and the second mechanism 6 could provide another function, notably:
another correction function, such as a function for correcting a calendar indication (day, date, month, year, etc.) or a function for correcting another indication (for example lunar phase).

The control device 1 comprises:
the input 2, which is intended to be rotated by the action of the user in a first direction or in a second direction,
a first unidirectional connector 3, which is intended to mechanically connect the input 2 to the first mechanism 5 providing the first timepiece function, and
a second unidirectional connector 4, which is intended to mechanically connect the input 2 to the second mechanism 6 providing the second timepiece function.

The first unidirectional connector 3 is arranged and/or configured to drive the first mechanism 5 exclusively when the input is manoeuvred in the first direction and the second unidirectional connector 4 is arranged and/or configured to drive the second mechanism 6 exclusively when the input is manoeuvred in the second direction. In particular, in the embodiment shown in FIG. 1, when the input is rotated in the clockwise direction about the axis A2, the input movement is transmitted to the second mechanism 6 exclusively and, when the input is rotated in the anticlockwise direction about the axis A2, the input movement is transmitted to the first mechanism 5 exclusively, as will be explained in detail below.

To provide this function, the first unidirectional connector 3 comprises first toothings 321, 331 which interact irreversibly and/or the second unidirectional connector 4 comprises second toothings 421, 431 which interact irreversibly.

Preferably, the input is a disc pivoted about the axis A2 on a frame 99 of the timepiece movement. The input 2 may be a shaft, a rod, a pinion or a wheel. The input has a toothing 21 for transmitting the movement it receives from the user via the crown or the knurling-roller or the key.

In the embodiment shown, the first unidirectional connector 3 comprises:
a first planetary wheel carrier 31,
a first planetary wheel 32 pivoted on the first planetary wheel carrier 31, and
a first sun gear 33 that meshes with the first planetary wheel 32 and is secured, notably rotationally fixed, to the input 2.

The first planetary wheel carrier 31 is pivoted about an axis A3 on the frame 99. The first planetary wheel carrier 31 comprises a toothing 311 securing the first connector to the first mechanism 5. The first planetary wheel 32 is pivoted on a plate of the planetary wheel carrier 31 about an axis A32 parallel to the axis A3. The first satellite 32 comprises one 321 of the first toothings. The first sun gear 33 is also pivoted about the axis A3 on the frame 99. This first sun gear comprises:
a toothing 332 meshing with the toothing 21 of the input 2, and
the other first toothing 331 interacting by meshing with the first toothing 321.

The sun gear 33 is for example made up of a pinion bearing the toothing 331, which pinion is fixed, notably riveted, to a wheel bearing the toothing 332.

The first toothings 321, 331 interact irreversibly inasmuch as the first toothings 321, 331 mesh irreversibly.

In the embodiment shown, the second unidirectional connector 4 comprises:
a second planetary wheel carrier 41,
a second planetary wheel 42 pivoted on the second planetary wheel carrier 41, and
a second sun gear 43 that meshes with the second planetary wheel 42 and is secured, notably rotationally fixed, to the input 2.

The second planetary wheel carrier 41 is pivoted about an axis A4 on the frame 99. The second planetary wheel carrier 41 comprises a toothing 411 securing the second connector to the second mechanism. The second planetary wheel 42 is pivoted on a plate of the planetary wheel carrier 41 about an axis A42 parallel to the axis A4. The second satellite 42 comprises one 421 of the second toothings. The second sun gear 43 is also pivoted about the axis A4 on the frame 99. This second sun gear comprises:
a toothing 432 meshing with the toothing 21 of the input 2, and
the other second toothing 431 interacting by meshing with the second toothing 421.

The sun gear 43 is for example made up of a pinion bearing the toothing 431, which pinion is fixed, notably riveted, to a wheel bearing the toothing 432.

The second toothings 421, 431 interact irreversibly inasmuch as the second toothings 421, 431 mesh irreversibly.

When the input 2 is rotated about the axis A2 in the anticlockwise direction, it rotates, by way of the interaction of the toothings 21 and 332, the sun gear 33 about the axis A3 in the clockwise direction. The first toothings 321, 331 become locked and the planetary wheel 32 is also rotated about the axis A3, consequently driving the planetary wheel carrier 31 about the axis A3 in the clockwise direction. It follows that the planetary wheel carrier 31 drives a wheel of the first mechanism 5 in the anticlockwise direction, via the interaction of the toothings 311 and 51.

When the input 2 is rotated about the axis A2 in the anticlockwise direction, it rotates, by way of the interaction of the toothings 21 and 432, the sun gear 43 about the axis A4 in the clockwise direction. The planetary wheel 42 is rotated about the axis A42 in the clockwise direction, the second toothings 421, 431 being able to mesh freely. Consequently, the planetary wheel carrier 41 is not rotated about the axis A4. It follows that the planetary wheel carrier 41 does not drive the wheel 61 of the second mechanism 6.

When the input 2 is rotated about the axis A2 in the clockwise direction, it rotates, by way of the interaction of the toothings 21 and 432, the sun gear 43 about the axis A4 in the anticlockwise direction. The second toothings 421, 431 become locked and the planetary wheel 42 is also rotated about the axis A4, consequently driving the planetary wheel carrier 41 about the axis A4 in the anticlockwise direction. It follows that the planetary wheel carrier 41 drives the wheel 61 (notably the ratchet 61) of the second mechanism 6 in the clockwise direction, via the interaction of the toothings 411 and 611.

When the input 2 is rotated about the axis A2 in the clockwise direction, it rotates, by way of the interaction of the toothings 21 and 332, the sun gear 33 about the axis A3 in the anticlockwise direction. The planetary wheel 32 is rotated about the axis A32 in the anticlockwise direction, the second toothings 321, 331 being able to mesh freely. Consequently, the planetary wheel carrier 31 is not rotated about the axis A3. It follows that the planetary wheel carrier 31 does not drive the wheel 51 of the first mechanism 5.

The first and second toothings are arranged and/or configured to become locked when the sun gear 33 is rotated in the clockwise direction in relation to the axis A3 and to become locked when the sun gear 43 is rotated in the anticlockwise direction in relation to the axis A4 alone. The toothings do not become locked when the planetary wheels are driven in the other directions. Furthermore, the toothings may also become locked when it is the planetary wheel carriers 31, 41 which provide drive in one direction or in the two directions or it is possible for the toothings not to become locked when the planetary wheel carriers 33, 43 are providing drive. However, this is not obligatory, non-obligatory, preferable or not preferable depending on the nature of the driven mechanisms 5, 6. For example, when the driven mechanism 6 is a barrel, it may not matter whether the toothings become locked or not. For example, when the driven mechanism 5 is a motion-work or a minutes disc, it is preferable for the toothings not to become locked, in order to limit the number of driven elements and to limit the losses of energy when there is no action on the input 2.

To realize these irreversible natures due to the locking of the toothings, one of the first or the second toothings may comprise teeth with asymmetric profiles and/or the other one of the first or the second toothings may comprise teeth with asymmetric profiles. An “asymmetric” profile means that each tooth has a first flank and a second flank, the first and second flanks not being symmetric relative to a radius of the wheel passing through the apex of the tooth.

By virtue of the solution shown, it is possible to adjust the time by turning the crown in one direction and to rewind the timepiece by turning the crown in an opposite direction. This is practical. Furthermore, the solution takes up little room in the direction perpendicular to the plane of FIG. 1.

In the embodiment described, the first sun gear 33 is secured, notably rotationally fixed, to the input 2 and the first planetary wheel carrier 31 is intended to be secured, notably rotationally fixed, to the first mechanism 5 and the second sun fear 43 is secured, notably rotationally fixed, to the input 2 and the second planetary wheel carrier is intended to be secured, notably rotationally fixed, to the second mechanism 6. In a variant, the first sun gear 33 may make up the input 2, such that the shaft 2 can be eliminated and the sun gears 33 and 43 can mesh with one another. In another variant, the second sun gear 43 may make up the input 2, such that the shaft 2 can be eliminated and the sun gears 33 and 43 can mesh with one another. When the input shaft is dispensed with and the sun gears mesh directly with one another, they rotate in the opposite direction and the rest of the device must consequently be adapted.

In another embodiment:
the first sun gear may be intended to be secured, notably rotationally fixed, to the first mechanism 5 and the first planetary wheel carrier may make up the input or be secured, notably rotationally fixed, to the input 2, and
the second sun gear may be intended to be secured, notably rotationally fixed, to the second mechanism 6 and the second planetary wheel carrier may make up the input or be secured, notably rotationally fixed, to the input 2.

In another embodiment:
the first unidirectional connector comprises two toothed wheels which are mounted coaxially against one another, which are returned against one another by a spring, which mesh respectively with the input and with the first mechanism, and each of which has a Breguet toothing on its plate, and
the second unidirectional connector comprises two toothed wheels which are mounted coaxially against one another, which are returned against one another by a spring, which mesh respectively with the input and with the second mechanism, and each of which has a Breguet toothing on its plate.

Thus, when the input is turned in a first direction, the two wheels of the first unidirectional connector are rotated, as is the first mechanism. By contrast, only one of the wheels of the second unidirectional connector is rotated and it does not drive either the other wheel or the second mechanism. Similarly, when the input is turned in a second direction, the two wheels of the second unidirectional connector are rotated, as is the second mechanism. By contrast, only one of the wheels of the first unidirectional connector is rotated and it does not drive either the other wheel or the first mechanism.

In another embodiment:
one of the unidirectional connectors is of the type with a sun gear, a planetary wheel carrier and a planetary wheel, and
the other of the unidirectional connectors is of the type with Breguet toothings, as described above.

In all of these embodiments, it is possible to dispense with the input shaft as mentioned in relation to the embodiment shown.

Irrespective of the embodiment or the variant described, the first unidirectional connector is centred on a first axis A3 and the second unidirectional connector is centred on a second axis A4, the first and second axes advantageously being parallel and distinct. However, irrespective of the embodiment or the variant described, the first and second axes may advantageously coincide. Such a configuration makes it possible to minimize the space taken up by the device in the plane of FIG. 1.

If the first and second axes A3, A4 coincide, the planetary wheel carriers may form one and the same piece or be a monobloc assembly or the first and second sun gears may form one and the same piece or be a monobloc assembly. In the embodiment with Breguet toothings, one and the same wheel may be common to the two unidirectional connectors and bear, on the two faces of its plate, two Breguet toothings interacting with the Breguet toothings of two other wheels.

The planetary wheel carriers described each bear one planetary wheel. Advantageously, each planetary wheel carrier may bear two planetary wheels or more, such as three planetary wheels or four planetary wheels.

Throughout this document, “two secured parts” is to be understood to mean that any movement of one of the parts involves a movement of the other one of the parts.

1. A control device for a timepiece, comprising:
an input, which is intended to be rotated by the action of a user in a first direction or in a second direction,
a first unidirectional connector, which is intended to mechanically connect the input to a first mechanism providing a first timepiece function, and
a second unidirectional connector, which is intended to mechanically connect the input to a second mechanism providing a second timepiece function,
the first unidirectional connector being arranged and/or configured to drive the first mechanism exclusively when the input is manoeuvred in the first direction,
the second unidirectional connector being arranged and/or configured to drive the second mechanism exclusively when the input is manoeuvred in the second direction,
the first unidirectional connector comprising first toothings which interact irreversibly and/or the second unidirectional connector comprising second toothings which interact irreversibly.

2. The control device according to claim 1, wherein the first unidirectional connector comprises:
a first planetary wheel carrier,
a first planetary wheel pivoted on the first planetary wheel carrier, and
a first sun gear meshing with the first planetary wheel,
the first toothings meshing irreversibly at the interface of the first planetary wheel and the first sun gear.

3. The control device according to claim 1, wherein the first planetary wheel carrier makes up the input or is secured to the input and the first sun gear is intended to be secured to the first mechanism, or wherein the first planetary wheel carrier is intended to be secured to the first mechanism and the first sun gear makes up the input or is secured to the input.

4. The control device according to claim 1, wherein the second unidirectional connector comprises:
a second planetary wheel carrier,
a second planetary wheel pivoted on the second planetary wheel carrier, and
a second sun gear meshing with the second planetary wheel,
the second toothings meshing irreversibly at the interface of the second planetary wheel and the second sun gear.

5. The control device according to claim 1, wherein the second planetary wheel carrier makes up the input or is secured to the input and the second sun gear is intended to be secured to the second mechanism, or wherein the second planetary wheel carrier is intended to be secured to the second mechanism and the second sun gear makes up the input or is secured to the input.

6. The control device according to claim 1, wherein the first toothings are Breguet toothings and/or the second toothings are Breguet toothings.

7. The control device according to claim 1, wherein the first unidirectional connector is centred on a first axis and wherein the second unidirectional connector is centred on a second axis, the first and second axes being parallel and distinct.

8. The control device according to claim 1, wherein the first unidirectional connector is centred on a first axis and wherein the second unidirectional connector is centred on a second axis, the first and second axes being one and a same.

9. The control device according to claim 2, wherein the first and second planetary wheel carriers form one and the same piece or are a monobloc assembly, or wherein the first and second sun gears form one and the same piece or are a monobloc assembly.

10. A timepiece movement comprising a control device according to claim 1.

11. A timepiece comprising the timepiece movement according to claim 10.

12. The timepiece according to claim 11, which is a wristwatch.

13. A timepiece comprising the control device according to claim 1.

14. The timepiece according to claim 13, which is a wristwatch.

15. The control device according to claim 4, wherein the first and second planetary wheel carriers form one and the same piece or are a monobloc assembly, or wherein the first and second sun gears form one and the same piece or are a monobloc assembly.

16. The control device according to claim 8, wherein the first and second planetary wheel carriers form one and the same piece or are a monobloc assembly, or wherein the first and second sun gears form one and the same piece or are a monobloc assembly.

17. The control device according to claim 2, wherein the first planetary wheel carrier makes up the input or is secured to the input and the first sun gear is intended to be secured to the first mechanism, or wherein the first planetary wheel carrier is intended to be secured to the first mechanism and the first sun gear makes up the input or is secured to the input.

18. The control device according to claim 17, wherein the second unidirectional connector comprises:
a second planetary wheel carrier,
a second planetary wheel pivoted on the second planetary wheel carrier, and
a second sun gear meshing with the second planetary wheel,
the second toothings meshing irreversibly at the interface of the second planetary wheel and the second sun gear.

19. The control device according to claim 2, wherein the second unidirectional connector comprises:
a second planetary wheel carrier,
a second planetary wheel pivoted on the second planetary wheel carrier, and
a second sun gear meshing with the second planetary wheel,
the second toothings meshing irreversibly at the interface of the second planetary wheel and the second sun gear.

20. The control device according to claim 3, wherein the second unidirectional connector comprises:
a second planetary wheel carrier,
a second planetary wheel pivoted on the second planetary wheel carrier, and
a second sun gear meshing with the second planetary wheel,
the second toothings meshing irreversibly at the interface of the second planetary wheel and the second sun gear.
